(19) United States
(12) Patent Application Publication
(10) Pub. No.: US 2014/0101026 A1
(43) Pub. Date: Apr. 10, 2014

(54) METHOD AND APPARATUS FOR PREVIEWING CREDIT REPORTING, CREDIT MONITORING, OR OTHER INFORMATION PRIOR TO SERVICE ENROLLMENT

(71) Applicant: One Technologies, LP, Dallas, TX (US)

(72) Inventors: Anthony J. Fiacable, Dallas, TX (US); Mark Edward Henry, Dallas, TX (US)

(73) Assignee: One Technologies, LP, Dallas, TX (US)

(21) Appl. No.: 14/046,761

(22) Filed: Oct. 4, 2013

Related U.S. Application Data
(60) Provisional application No. 61/794,329, filed on Mar. 15, 2013.
(60) Provisional application No. 61/709,486, filed on Oct. 4, 2012.

(51) Int. Cl. G06Q 40/02

(52) U.S. Cl. CPC G06Q 40/025
USPC 705/38

(57) ABSTRACT

A method includes receiving information over a network from a user device associated with a customer attempting to enroll in a service. The method also includes identifying service-related information associated with the customer. The service-related information includes a subset or summary of information to be made available to the customer after the customer enrolls in the service. In addition, the method includes, prior to enrolling the customer in the service, presenting the service-related information to the customer. The service could include a credit reporting service or a credit monitoring service. The service-related information could include a summary of at least a portion of the customer's credit report, along with a comparison of the summary of at least the portion of the customer's credit report to an average value.

### CROSS-REFERENCE TO RELATED APPLICATIONS AND PRIORITY CLAIM

This application claims priority under 35 U.S.C. §119(e) to the following applications:

U.S. Provisional Patent Application No. 61/709,486 filed on Oct. 4, 2012; and

U.S. Provisional Patent Application No. 61/794,329 filed on Mar. 15, 2013.

Both of these provisional applications are hereby incorporated by reference in their entirety.

### TECHNICAL FIELD

This disclosure relates generally to service delivery over a network such as the Internet. More specifically, this disclosure relates to a method and apparatus for previewing credit reporting, credit monitoring, or other information prior to service enrollment.

### BACKGROUND

Numerous services are offered to customers over the Internet. Two examples are credit reporting services and credit monitoring services. Credit reporting services typically allow customers to receive their credit reports, possibly along with their credit scores, from one or more credit bureaus. Credit monitoring services typically monitor credit bureaus' records and possibly other entities' records, such as those of banks, credit card companies, and other companies that can affect the customers' credit ratings.

### SUMMARY

This disclosure provides a method and apparatus for previewing credit reporting, credit monitoring, or other information prior to service enrollment.

In a first embodiment, a method includes receiving information over a network from a user device associated with a customer attempting to enroll in a service. The method also includes identifying service-related information associated with the customer. The service-related information includes a subset or summary of information to be made available to the customer after the customer enrolls in the service. In addition, the method includes, prior to enrolling the customer in the service, presenting the service-related information to the customer.

In a second embodiment, an apparatus includes at least one interface configured to receive information over a network from a user device associated with a customer attempting to enroll in a service. The apparatus also includes at least one processing device configured to identify service-related information associated with the customer and, prior to enrolling the customer in the service, provide the service-related information to the customer. The service-related information includes a subset or summary of information to be made available to the customer after the customer enrolls in the service.

In a third embodiment, a non-transitory computer readable medium embodies a computer program. The computer program includes computer readable program code for obtaining information over a network from a user device associated with a customer attempting to enroll in a service. The computer program also includes computer readable program code for obtaining service-related information associated with the customer. The service-related information includes a subset or summary of information to be made available to the customer after the customer enrolls in the service. The computer program further includes computer readable program code for, prior to enrolling the customer in the service, presenting the service-related information to the customer.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting enrollment in credit reporting, credit monitoring, or other services in accordance with this disclosure;

FIG. 2 illustrates an example computing device that can be used in the system of FIG. 1 in accordance with this disclosure;

FIG. 3 illustrates an example method for enrollment in credit reporting, credit monitoring, or other services in accordance with this disclosure;

FIGS. 4A through 4E illustrate an example graphical user interface that supports enrollment in credit reporting, credit monitoring, or other services in accordance with this disclosure;

FIGS. 5A through 5E illustrate another example graphical user interface that supports enrollment in credit reporting, credit monitoring, or other services in accordance with this disclosure;

FIG. 6 illustrates an example method for previewing credit reporting, credit monitoring, or other information prior to service enrollment in accordance with this disclosure; and

FIGS. 7A through 7E illustrate an example graphical user interface that supports previewing credit reporting, credit monitoring, or other information prior to service enrollment in accordance with this disclosure.

### DETAILED DESCRIPTION

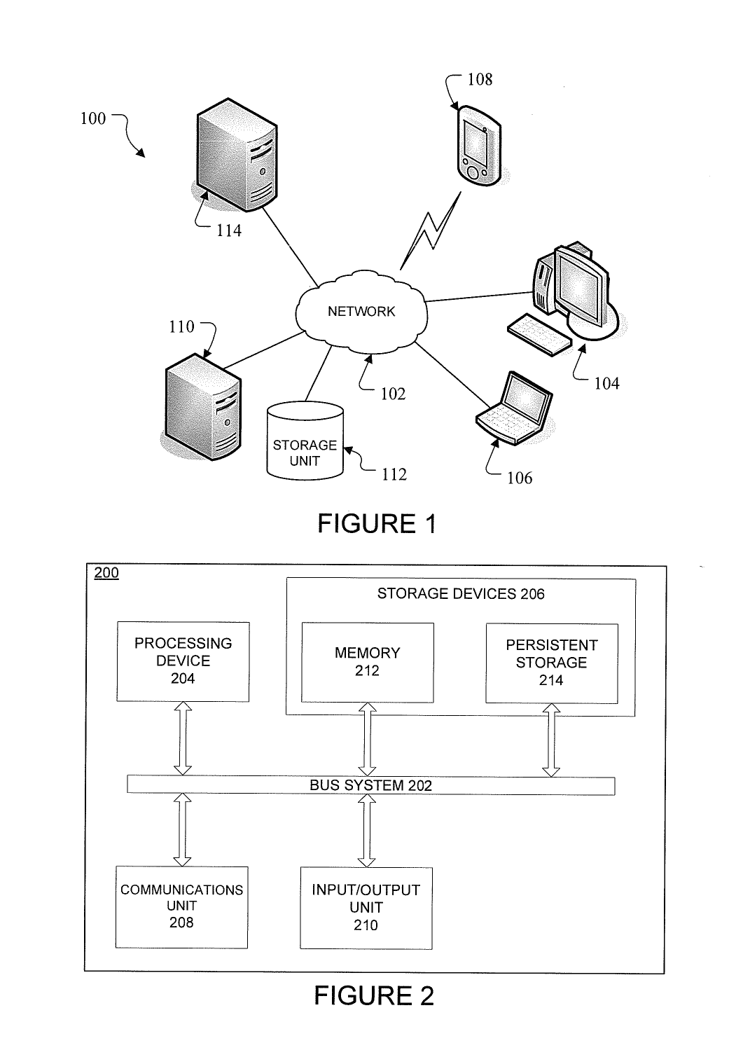

FIGS. 1 through 7E, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 supporting enrollment in credit reporting, credit monitoring, or other services in accordance with this disclosure. As shown in FIG. 1, the system 100 includes a network 102, which facilitates communication between various components in the system 100. For example, the network 102 may communicate Internet Protocol (IP) packets, frame relay frames, Asynchronous Transfer Mode (ATM) cells, or other information between network addresses. The network 102 may include one or more local area networks (LANs), metropolitan area networks (MANs), wide area networks (WANs), all or a portion of a global network such as the Internet, or any other communication system or systems at one or more locations.

The system 100 also includes various user devices 104-108. The user devices 104-108 represent computing or communication devices used by customers to perform various functions, such as enrolling in a credit reporting service, a credit monitoring service, or other service over the network 102. Each user device 104-108 includes any suitable device that communicates over a network and supports interaction with other devices. Each user device 104-108 can also communicate using any suitable wired or wireless communication mechanism. In this example, the user devices 104-108 include a desktop computer, a laptop computer, and a smartphone or personal digital assistant. However, any other or additional type(s) of user device(s) could be used in the system 100, such as a tablet computer.

One or more servers 110 support the enrollment of customers into at least one service and may also provide the service(s). For example, the servers 110 could allow a customer to sign up for credit reporting, credit monitoring, or other services based upon information provided by the customer via a user device. The servers 110 can also support verification of the customer's identity prior to providing a service to the customer. The servers 110 can further collect the customer's billing information and provide the service. In addition, the servers 110 could provide the customer a “sneak peak” or preview of service-related information prior to collecting the customer's billing information and providing the service (which may help to entice the customer to enroll in the service). Each server 110 includes any suitable computing device or other device for performing a desired function related to a service. For instance, a web server could be used to interact with web browsers on the user devices 104-108 over the network 102, and an application server could be used to execute applications such as for customer identification and verification or for presentation of service-related preview information.

One or more storage units 112 store and facilitate retrieval of data used by the servers 110. For example, the storage units 112 could store account information associated with customers who have registered for a service, along with information about the service. Each storage unit 112 includes any suitable data storage and retrieval device(s).

The specific functions performed by the servers 110 when providing a service and the specific data stored by the storage units 112 vary depending on the type of service(s) being offered. For example, depending on the service, the servers 110 may interact with various third-party servers 114. The third-party servers 114 may represent computing devices used by entities that are not providing the service. As a particular example, to provide credit reporting or credit monitoring services, the servers 110 could retrieve data from servers 114 operated by credit bureaus, banks, credit card companies, and the like. Note that there may be a business or other relationship between the entity providing a service and the entity operating a server 114, such as when a subsidiary of a credit bureau provides a credit reporting or credit monitoring service.

Each computing device in FIG. 1 (such as each user device 104-108, server 110, and server 114) includes any suitable structure for performing the described functions. Each computing device could, for example, include one or more processing units, one or more memory units storing data and instructions used, generated, or collected by the processing unit(s), and one or more interfaces for communicating over the network 102 or other communication link(s).

As described in more detail below, one or more of the servers 110 support a process for handling enrollment of customers in a service, such as a credit reporting or credit monitoring service. The process enables more accurate and complete collection of customer information and helps to ensure that a customer is able to retrieve service-related information after enrollment in a service. Also as described in more detail below, one or more of the servers 110 support a process that entices customers to sign up for a service by providing a preview of service-related information prior to customer enrollment in the service. Note that both processes can be used together or separately.

Although FIG. 1 illustrates one example of a system 100 supporting enrollment in credit reporting, credit monitoring, or other services, various changes may be made to FIG. 1. For example, the process for handling enrollment could be performed by any suitable device in any suitable system. Also, the process for handling enrollment could be used in conjunction with any suitable service. Moreover, while FIG. 1 is intended as an example system where a process for handling enrollment could be used, other systems such as those having different components or a different configuration of components could be used.

FIG. 2 illustrates an example computing device 200 that can be used in the system 100 of FIG. 1 in accordance with this disclosure. The computing device 200 could, for example, be used to implement any of the user devices 104-108, servers 110 or 114, or storage unit 112 in FIG. 1.

As shown in FIG. 2, the computing device 200 includes a bus system 202, which supports communication between at least one processing device 204, at least one storage device 206, at least one communications unit 208, and at least one input/output unit 210.

The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry. The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a hard drive, flash memory, optical disc, or rewritable magnetic tape.

The communications unit 208 supports communications with other systems or devices. For example, the communications unit 208 could include a network interface card or a wireless transceiver. The communications unit 208 may support communications through any suitable physical or wireless communication link(s).

The input/output unit 210 allows for input and output of data. For example, the input/output unit 210 may provide a connection for user input through a keyboard, mouse, keypad, touchscreen, or other suitable input device. The input/output unit 210 may also send output to a display, printer, or other suitable output device.

In some embodiments, the computing device 200 represents any of the user devices 104-108 in the system 100 of FIG. 1. In these embodiments, the computing device 200 could support interaction with the server 110 over the network 102, such as via a web browser. The computing device 200 could also support other operations depending on the implementation. For instance, the processing device(s) 204 in a computing device 200 that represents a desktop or laptop computer could execute a wide range of applications in addition to a web browser or other application facilitating communication with the server 110. The processing device(s) 204 in a computing device 200 that represents a mobile telephone could execute applications supporting telephone calls, text messaging, and other applications in addition to a web browser or other application facilitating communication with the server 110.

In other embodiments, the computing device 200 represents the servers 110 in the system 100 of FIG. 1. In these embodiments, the processing device(s) 204 could execute applications to verify a potential customer's identity, provide a preview of service-related information, enroll the potential customer in a service, and bill the customer after enrollment in the service. The processing device(s) 204 in the servers 110 could perform any other suitable functions, whether or not related to a service.

Although FIG. 2 illustrates one example of a computing device 200 that can be used in the system 100 of FIG. 1, various changes may be made to FIG. 2. For example, the embodiment of the computing device 200 shown in FIG. 2 is for illustration only. Other devices containing other or additional components could be used to support various functions in the system 100 of FIG. 1.

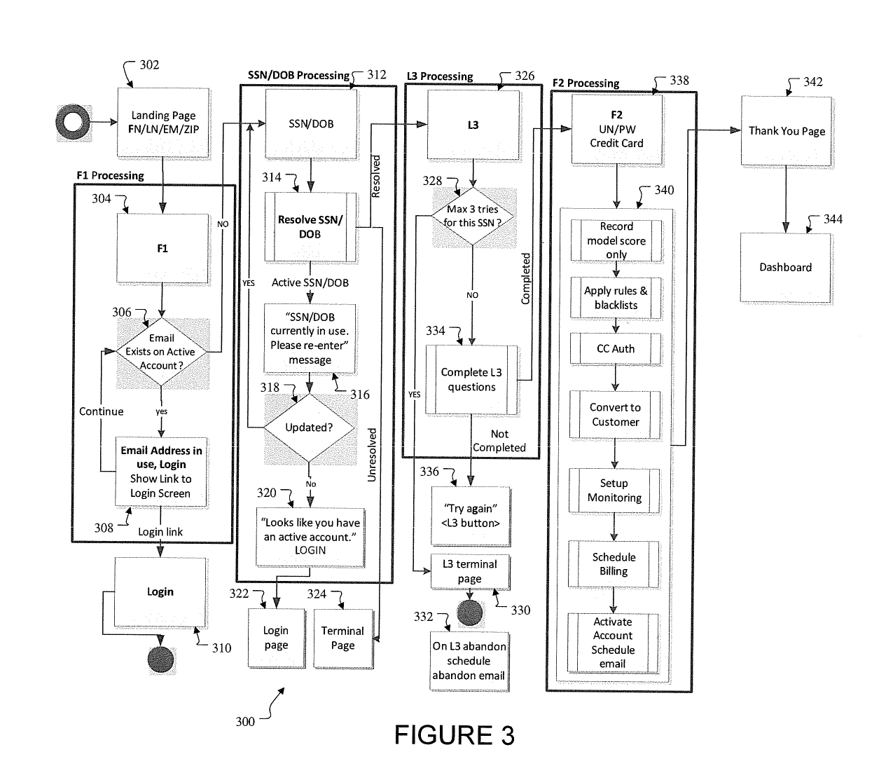

FIG. 3 illustrates an example method 300 for enrollment in credit reporting, credit monitoring, or other services in accordance with this disclosure. In this particular example, the method 300 is shown as being used to enroll a customer in a credit monitoring service. However, the method 300 could easily be modified to support enrollment in any number of other services.

As shown in FIG. 3, the method 300 begins with a customer accessing a landing page over a network at step 302. This could include, for example, the customer using a user device 104-108 to access the server 110 over the network 102. The landing page could provide general information about a service being offered by a service provider. The landing page could also provide a link for enrolling in the service and may include text boxes requesting initial information from the customer, such as the customer's first name (FN), last name (LN), email address (EM), and partial or complete physical address like zip code (ZIP).

If the customer elects to enroll in the service, initial information or “F1” processing occurs. During this processing, initial information about the customer is obtained at step 304. This could include, for example, the server 110 collecting information such as the customer's name, email address, and physical address. A determination is made whether the customer is already enrolled in the service based on the provided information at step 306. This could include, for example, the server 110 determining whether the provided email address is already associated with an active account. If so, the customer is notified that the provided email address is already in use with an existing account, and the customer is given the option of logging into the existing account at step 308. The customer could then return to step 306 to provide a different email address or access an account login page at step 310.

If a determination is made at step 306 that the customer is not already enrolled in the service based on the provided information, Social Security number (SSN) and date of birth (DOB) processing occurs. During this processing, the customer's Social Security number and date of birth are obtained at step 312. This could include, for example, the server 110 presenting a graphical user interface and collecting this information from the customer via a user device 104-108. SSN/DOB resolution occurs at step 314. This could include, for example, the server 110 using local information (such as in the storage unit 112) or another system (such as a remote server 114) to verify that the Social Security number and date of birth provided by the customer match, meaning they are associated with the same person. This could also include the server 110 verifying whether the provided Social Security number and date of birth are associated with an active account. Note that it is possible for a customer to provide a different email address than the one associated with an active account, so step 306 could determine that the customer is a new customer even though he or she already has an active account. Step 314 helps to identify those situations where a customer with an active account is attempting to sign up for a service with a different email address.

If the Social Security number and date of birth are already associated with an existing account, the customer is notified and given an opportunity to re-enter different data at step 316. If a determination is made at step 318 that the customer does not wish to update the data, the customer is notified that he or she has an active account at step 320 and is redirected to the account login page at step 322. If a determination is made at step 318 that the customer does wish to update the data, the process returns to step 312 to collect new Social Security number or date of birth information.

If the Social Security number and date of birth provided by the customer are not associated with an existing account and cannot be resolved at step 314, the customer is directed to a terminal page at step 324. The terminal page can notify the customer that the enrollment process cannot continue due to the inability to resolve the customer's Social Security number and date of birth. Note that the system could track the number of attempts made for a given Social Security number to identify repeated attempts to sign up for service with the same Social Security number and different birth dates. This information could be used in any suitable manner, such as by disabling account signup with that Social Security number over the network.

If the Social Security number and date of birth provided by the customer are not associated with an existing account and can be resolved at step 314, authentication or “L3” processing is initiated. During this processing, security information for the customer is retrieved at step 326. This could include, for example, the server 110 using the customer's data to initiate access to and retrieval of local information (such as in the storage unit 112) or remote information (such as at a remote server 114), where the retrieved information can be used to verify the customer's identity. The security information obtained here is received from a source other than the customer, meaning the security information does not come from the customer in this step. A determination is made whether excessive attempts have been made with the customer's Social Security number at step 328. This check can be made to determine whether the customer has failed to confirm his or her identity even though the customer's Social Security number and date of birth have been resolved. In this example, the maximum number of attempts per Social Security number is three, although other thresholds could be used. If excessive attempts have been made, the customer is redirected to an authentication terminal page notifying the customer that the process cannot continue at step 330, and an email notification could be scheduled for the customer at step 332.

If excessive attempts have not been made, the customer is given the opportunity to answer or complete various security questions used to verify the customer's identity at step 334. This could include, for example, the server 110 presenting a graphical user interface asking the customer about current or prior addresses, mortgage loans, or automobile loans. Any other suitable questions could be used to verify the customer's identity. If the customer cannot complete the questions (such as with the correct answers within a specified amount of time), the customer is given the option of trying again at step 336, or the process can be terminated if excessive attempts have been made in light of the latest failed verification.

If the customer successfully completes the questions at step 334, “F2” processing occurs. During this processing, additional information from the customer is obtained at step 338. This could include, for example, the server 110 presenting a graphical user interface and collecting information such as a username and password (UN/PW) for the customer's new online account. The server 110 could also collect credit card information and other information from the customer.

Once the necessary billing information has been collected, various operations 340 can occur on the back-end by the service provider's system. In this example, these operations 340 can be performed to establish a credit monitoring service for the customer (although other services could also be supported). Here, the operations 340 include recording one or more credit scores, applying rules and blacklists for credit monitoring, and performing a credit card authorization. The operations 340 also include converting the potential customer into an actual customer of the service and setting up credit monitoring for the actual customer. The operations 340 further include scheduling billing of the customer, activating the customer's online account, and scheduling emails for the customer. The type(s) of operations 340 performed here vary depending on the type of service in which the customer is enrolling. The customer is presented with a page thanking the customer for enrolling in the service at step 342, and the customer is redirected to a service dashboard at step 344.

Although FIG. 3 illustrates one example of a method 300 for enrollment in credit reporting, credit monitoring, or other services, various changes may be made to FIG. 3. For example, while FIG. 3 shows a series of steps, various steps in FIG. 3 could overlap, occur in parallel, occur in a different order, or occur any number of times. Also, various steps in FIG. 3 could be omitted and additional steps could be added according to particular needs.

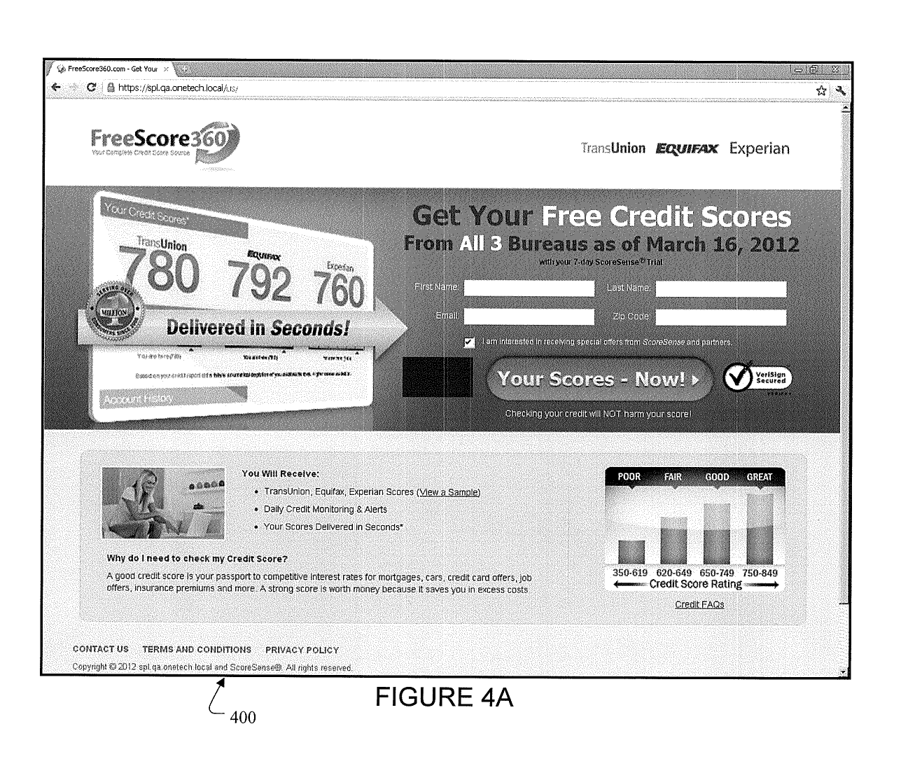

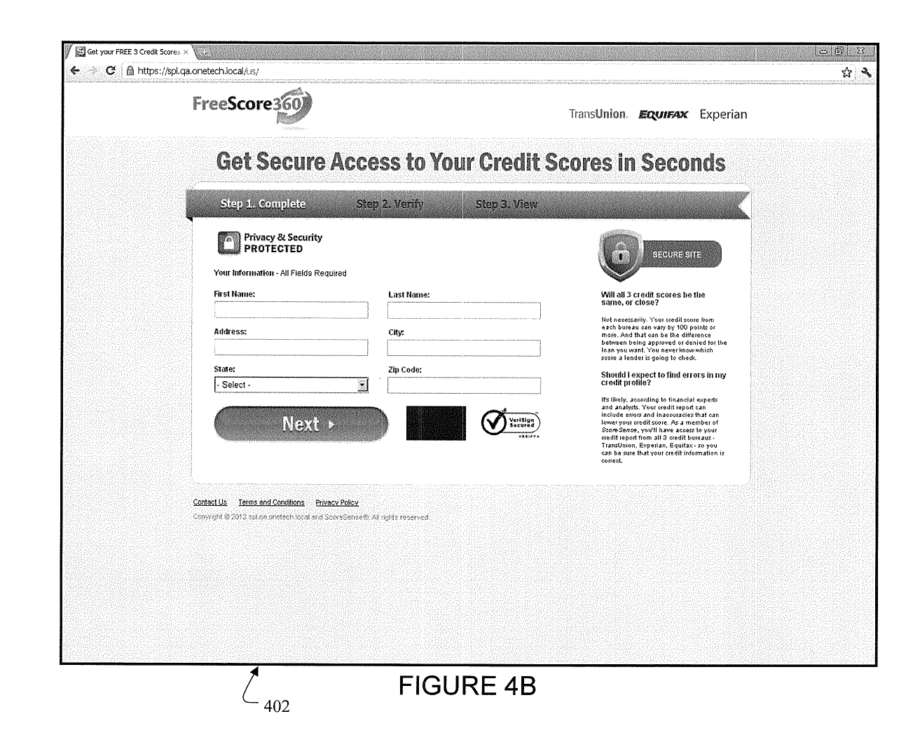

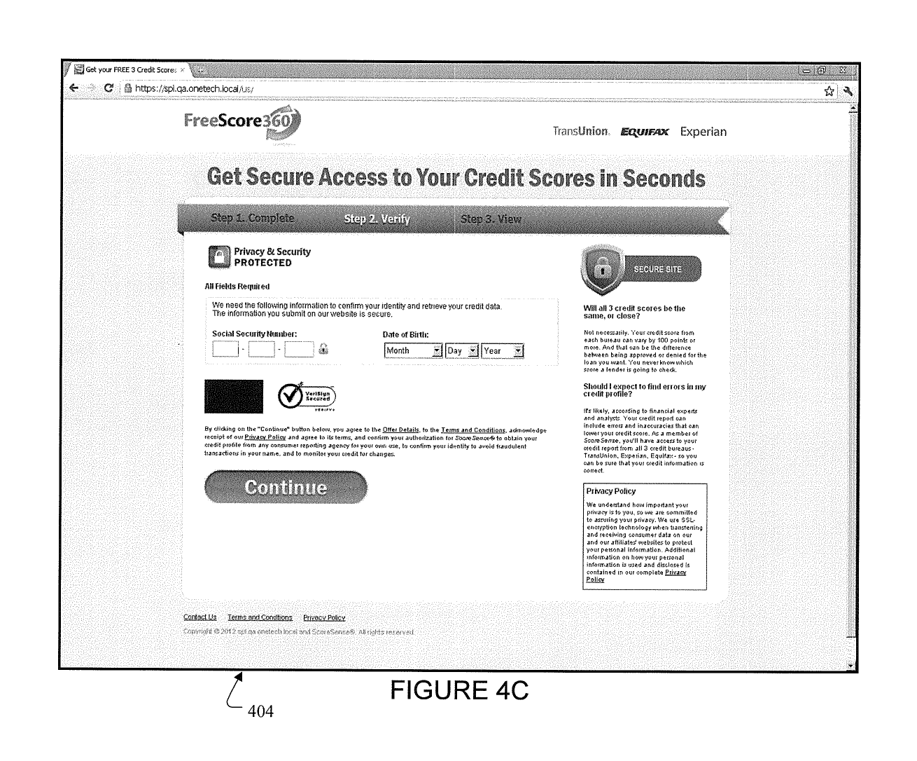

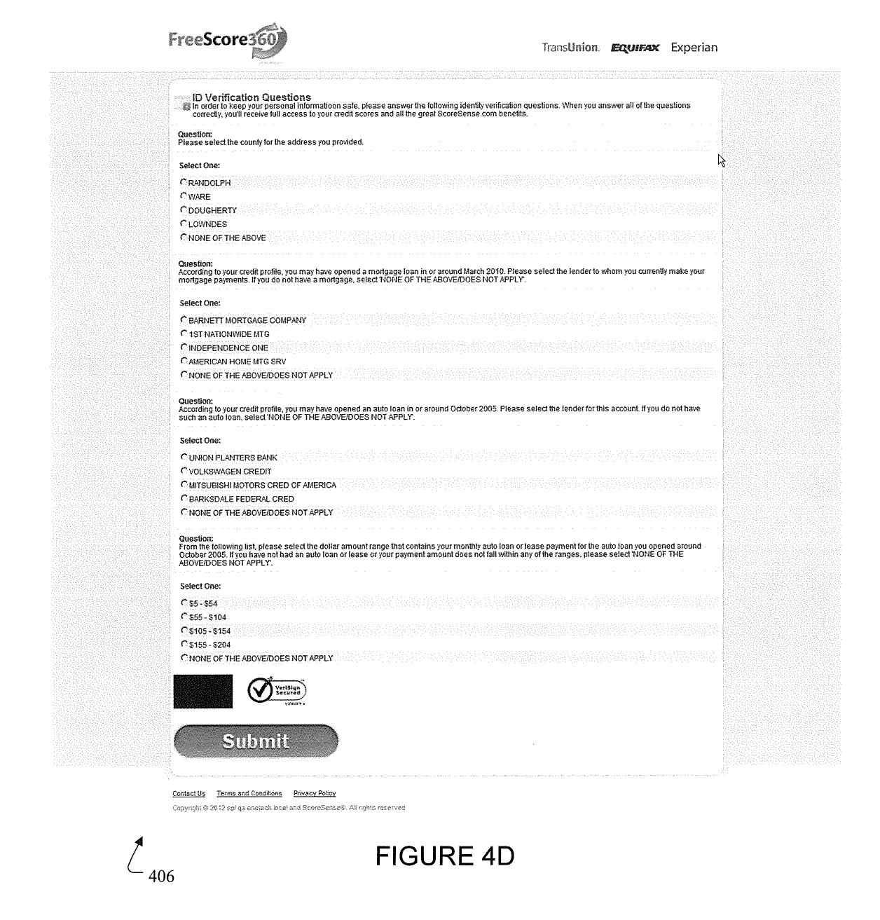

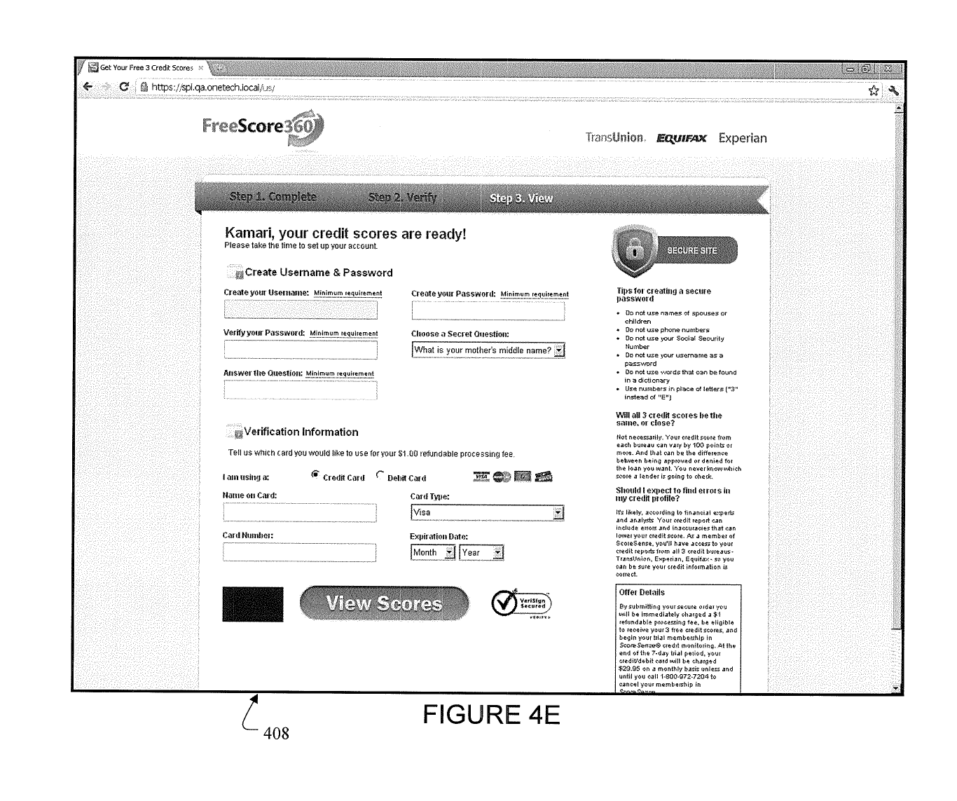

FIGS. 4A through 4E illustrate an example graphical user interface that supports enrollment in credit reporting, credit monitoring, or other services in accordance with this disclosure. In particular, FIGS. 4A through 4E illustrate a graphical user interface that can be provided on a desktop computer, laptop computer, tablet computer, or other device having a larger screen. However, the graphical user interface shown here could also be displayed on a smaller screen.

FIG. 4A illustrates an example web page 400 that could be used to provide information about a service and collect initial information from a customer (such as in step 302 of the method 300). In this example, the web page 400 asks the customer to provide his or her first name, last name, email address, and zip code. The customer is also asked whether he or she wishes to receive special offers from the service provider.

FIG. 4B illustrates an example web page 402 that could be used to collect additional information from the customer (such as in step 304 of the method 300) after the customer provides the initial information in FIG. 4A. In this example, the web page 402 asks the customer to enter his or her full mailing address. Note that the first name, last name, and zip code of the customer in FIG. 4B could be pre-populated based on the information entered in FIG. 4A (although this need not occur). Also note that FIGS. 4A and 4B could be combined to collect all of this information using a single web page.

FIG. 4C illustrates an example web page 404 that could be used to collect Social Security and date of birth information from the customer (such as in step 312 of the method 300).

FIG. 4D illustrates an example web page 406 that could be used to verify the customer's identity (such as in step 334 of the method 300). As shown in FIG. 4D, the web page 406 includes a list of questions relating to the customer. In this particular example, the questions may relate to the customer's current or previous residence(s), current or previous mortgage loan(s), and current or previous automobile loan(s). However, any other suitable questions could be used to verify the customer's identity.

FIG. 4E illustrates an example web page 408 that could be used to collect information after the customer's identity has been verified (such as in step 338 of the method 300). As shown in FIG. 4E, the web page 408 allows the customer to create an online account, define a security question, and provide billing information.

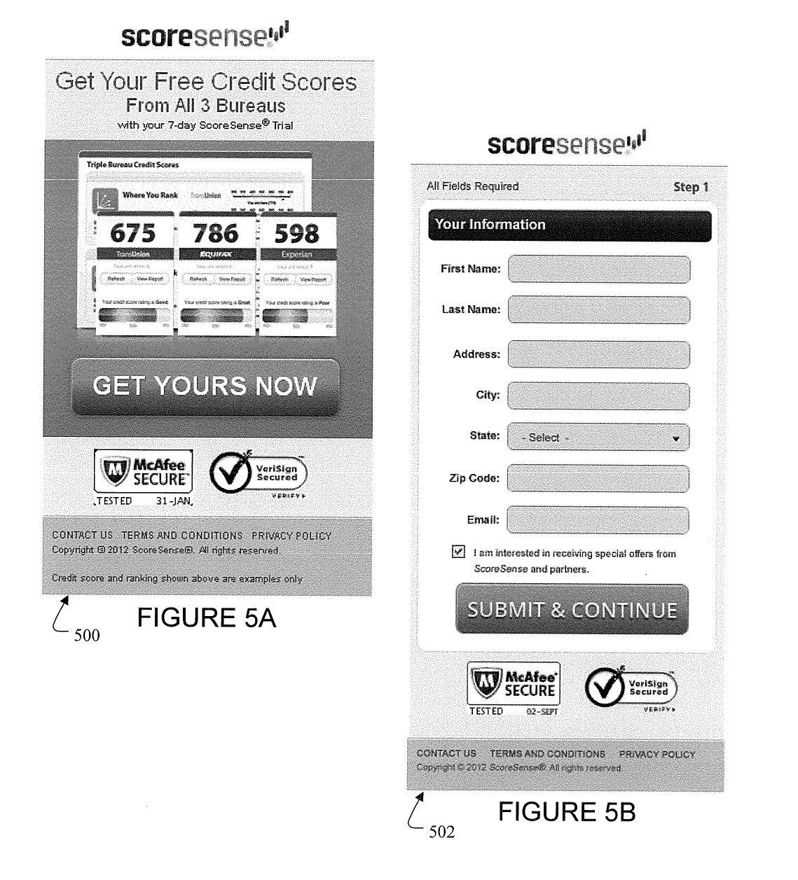

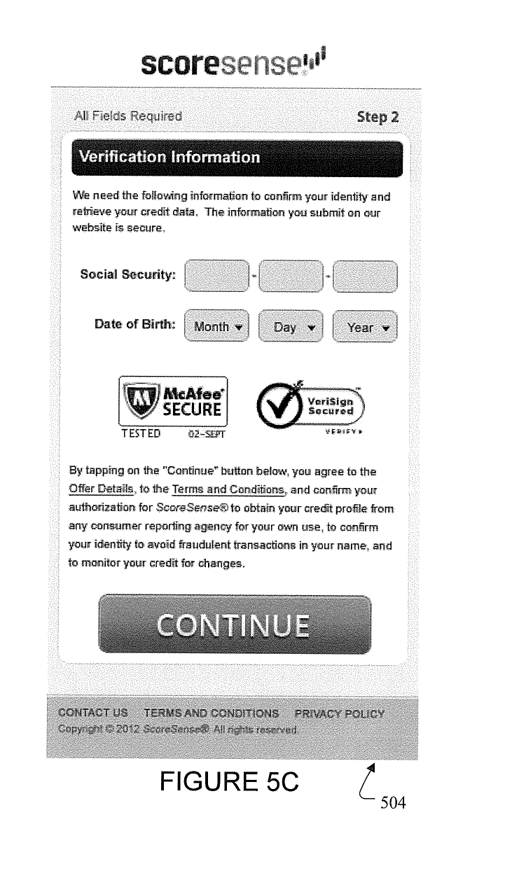

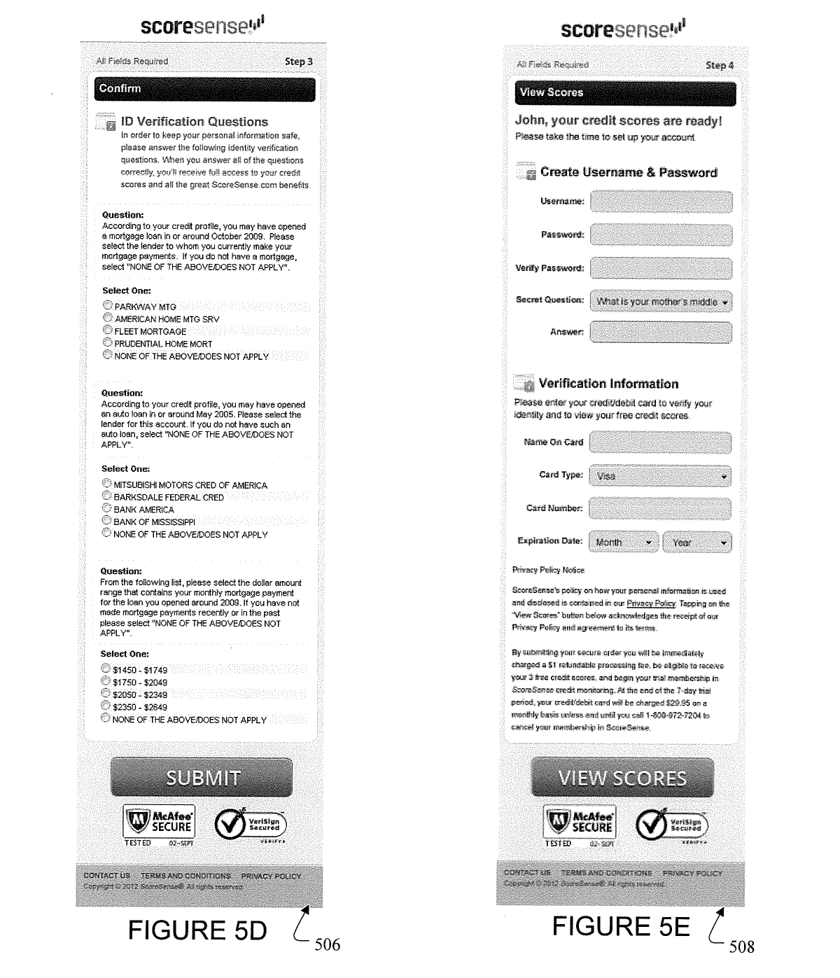

FIGS. 5A through 5E illustrate another example graphical user interface that supports enrollment in credit reporting, credit monitoring, or other services in accordance with this disclosure. In particular, FIGS. 5A through 5E illustrate a graphical user interface that can be provided on a smartphone, personal digital assistant, tablet computer, or other device having a smaller screen. However, the graphical user interface shown here could also be displayed on a larger screen.

FIG. 5A illustrates an example web page 500 used as a landing page that describes a service, which could be used to initiate the enrollment process (such as in step 302 of the method 300). FIG. 5B illustrates an example web page 502 that could be used to collect information from a customer (such as in step 304 of the method 300). In this example, the web page 502 asks the customer to provide his or her first name, last name, physical address, and email address. The customer is also asked whether he or she wishes to receive special offers from the service provider. FIG. 5C illustrates an example web page 504 that could be used to collect Social Security and date of birth information from the customer (such as in step 312 of the method 300). FIG. 5D illustrates an example web page 506 that could be used to verify the customer's identity (such as in step 334 of the method 300). FIG. 5E illustrates an example web page 508 that could be used to collect information after the customer's identity has been verified (such as in step 338 of the method 300). As shown in FIG. 5E, the web page 508 allows the customer to create an online account, define a security question, and provide billing information.

Although FIGS. 4A through 5E illustrate examples of graphical user interfaces that support enrollment in credit reporting, credit monitoring, or other services, various changes may be made to FIGS. 4A through 5E. For example, information from a customer could be collected in any suitable manner using any suitable input mechanisms. Also, the identity of a customer could be confirmed in any suitable manner.

Note that in the description above, the customer provides initial information and the customer's identity is verified/confirmed before the customer is asked to create an online account and provide billing information. This can be advantageous and solve various problems in the industry. For instance, service providers typically require a customer to create an online account and provide billing information (thereby enrolling the customer in a service) before the identity of the customer is verified. It is common for customers to create online accounts and enroll in a service but then fail to verify their identities properly. For example, a customer may be unable to remember details of his or her past loans and therefore fail to answer the authentication questions correctly. When that happens, a customer can actually be enrolled in and billed for a service, but the customer is unable to access information related to that service. For instance, a customer could be billed monthly for a credit monitoring service, but the customer may not be able to access the customer's credit reports or other sensitive information. Such a situation is clearly undesirable for both the customer and the service provider.

The approach described above helps to alleviate these problems by verifying the customer's identity before allowing the customer to create an online account and officially enroll in a service. From the customer's perspective, this is desirable since the customer is able to immediately access his or her service-related information upon completion of the enrollment process. From the service provider's perspective, this is desirable because the service provider knows with a higher degree of confidence that the service provider's customers are actually receiving the services for which they have enrolled.

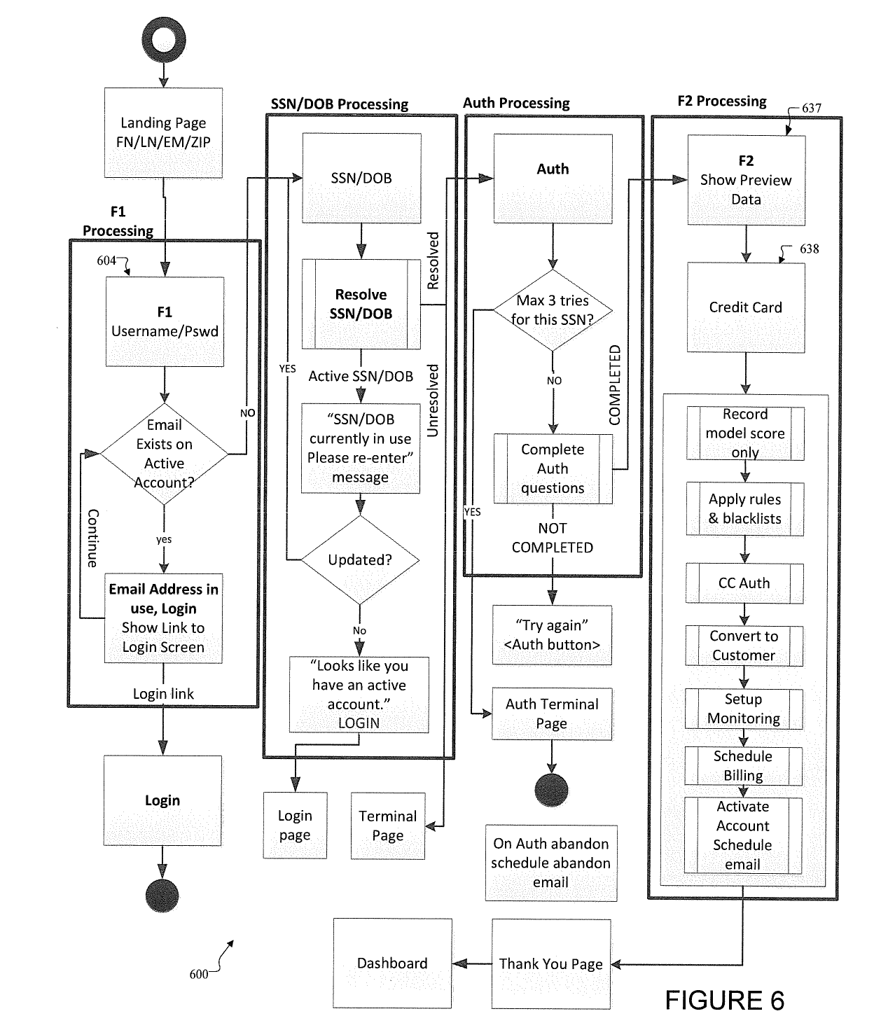

FIG. 6 illustrates an example method 600 for previewing credit reporting, credit monitoring, or other information prior to service enrollment in accordance with this disclosure. The method 600 here is similar to the method 300 of FIG. 3. For this reason, only those steps that are different from the steps of FIG. 3 are described below.

As shown in FIG. 6, the method 600 generally includes “F1” processing, SSN/DOB processing, authentication processing, and “F2” processing. These overall operations are generally described above. However, in FIG. 6, a username and password are collected at step 604 in the “F1” processing (which had occurred during “F2” processing in FIG. 3).

As another change, prior to collecting credit card information at step 638 in FIG. 6, preview data is presented to the customer at step 637 during “F2” processing in FIG. 6. This preview data represents a “sneak peak” at the customer's credit reporting, credit monitoring, or other service-related information. Any suitable service-related information could be used as a preview. For example, with a credit reporting or credit monitoring service, the preview data could represent a portion of one or more of the customer's credit reports. The preview data could also represent a summary of the customer's credit report(s), such as the number of credit cards, mortgages, other loans, or credit inquiries listed in the customer's credit report(s). By presenting this information to the customer, this can entice the customer to sign up for the service by providing his or her credit card.

Any suitable amount of service-related information can be presented to the customer during a preview, and the information can change from customer to customer, at different times, or in any other suitable manner. For example, a credit report often includes various types of information, such as current or prior credit accounts, debts, and credit inquiries. The preview presented to a particular customer could include a portion or summary of any of these types or other types of information. Also, the information presented to different customers can represent different portions or summaries of their respective credit reports. Of course, customers could also preview the same portions or summaries of their respective credit reports.

Although FIG. 6 illustrates one example of a method 600 for previewing credit reporting, credit monitoring, or other information prior to service enrollment, various changes may be made to FIG. 6. For example, while FIG. 6 shows a series of steps, various steps in FIG. 6 could overlap, occur in parallel, occur in a different order, or occur any number of times. An example of this is shown in FIGS. 3 and 6, where username and password collection is different. This could occur for any other or additional information. Also, various steps in FIG. 6 could be omitted and additional steps could be added according to particular needs.

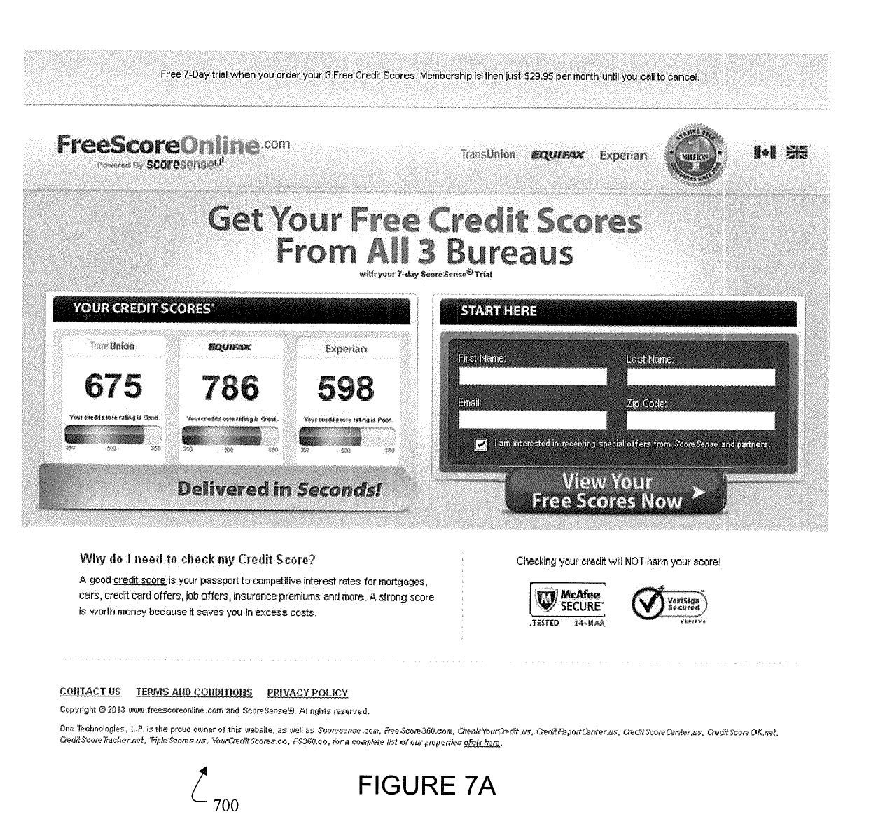

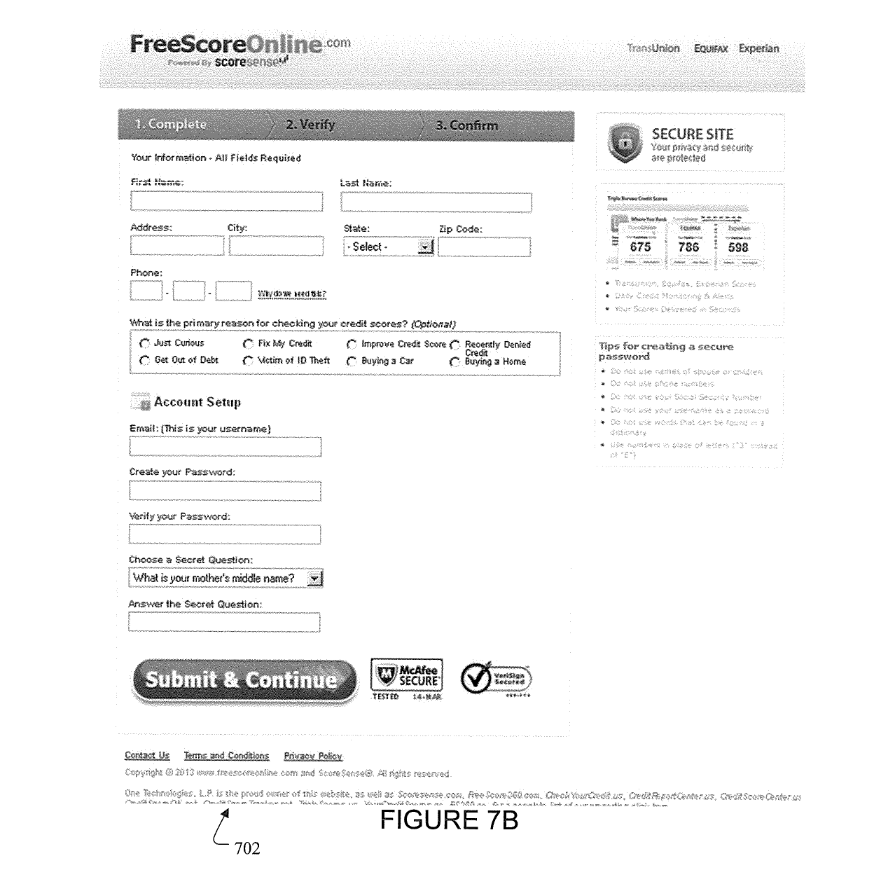

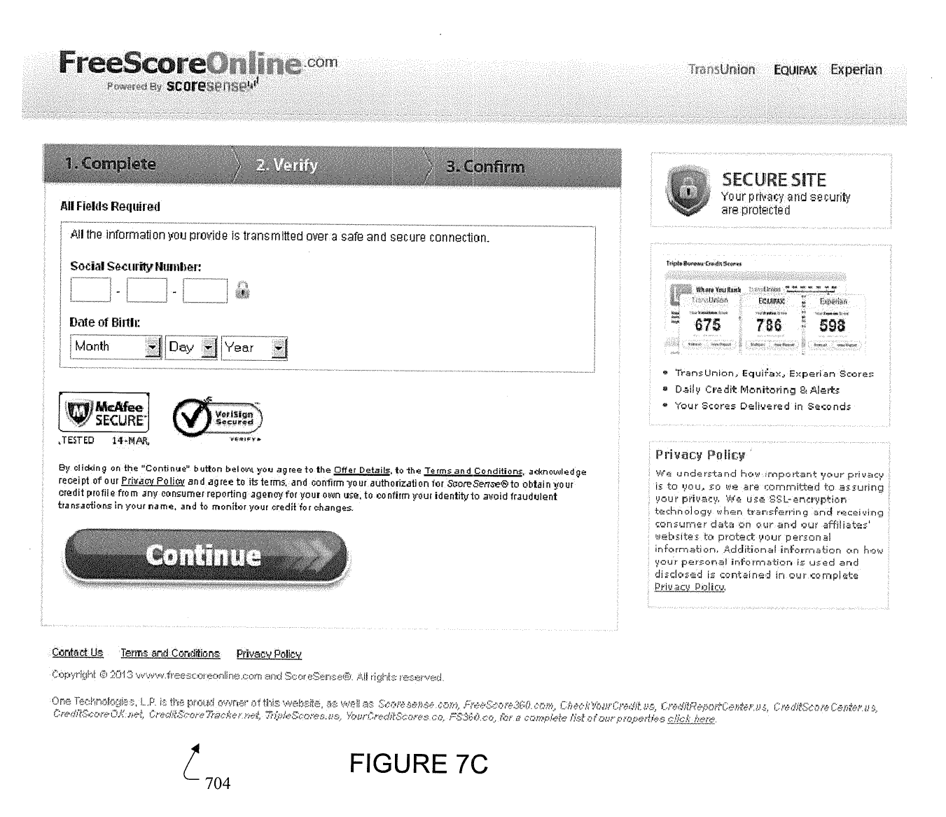

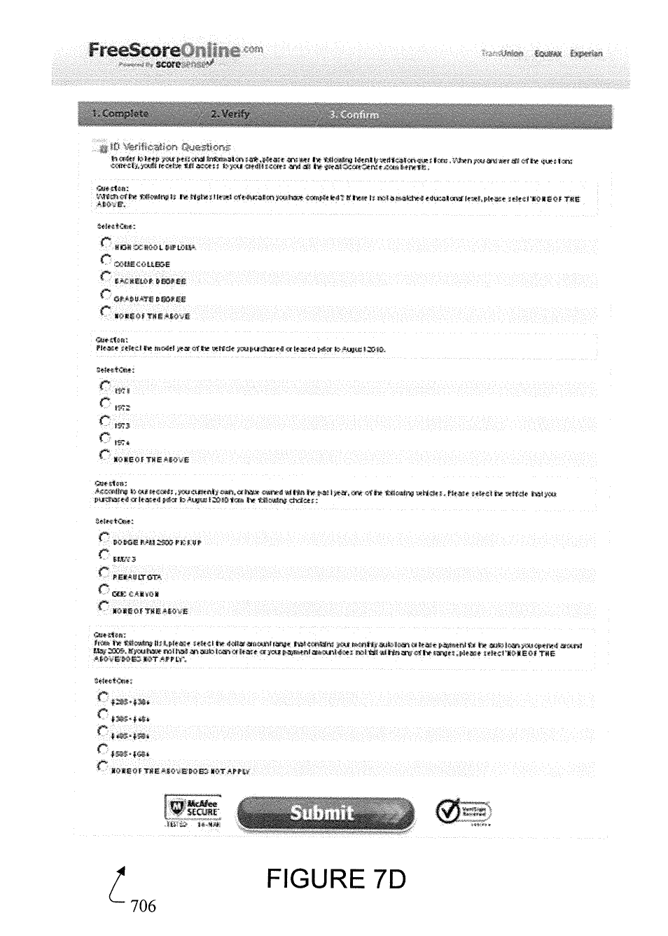

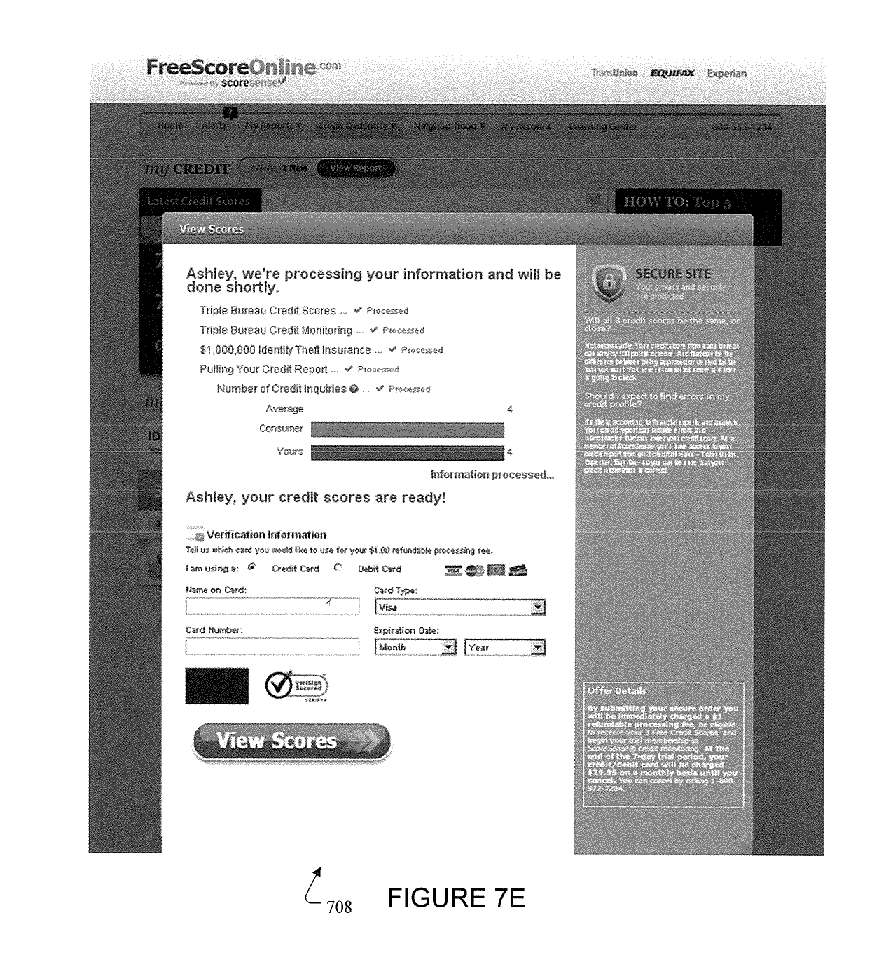

FIGS. 7A through 7E illustrate an example graphical user interface that supports previewing credit reporting, credit monitoring, or other information prior to service enrollment in accordance with this disclosure. In particular, FIGS. 7A through 7E illustrate a graphical user interface that can be provided on a desktop computer, laptop computer, tablet computer, or other device having a larger screen. Note that the same graphical user interface or another graphical user interface (such as one similar to that of FIGS. 5A through 5E) could be used to support previewing credit reporting, credit monitoring, or other information prior to service enrollment on other devices, such as devices with smaller screens.

FIG. 7A illustrates an example web page 700 that could be used to provide information about a service and collect initial information from a customer. In this example, the web page 700 asks the customer to provide his or her first name, last name, email address, and zip code. The customer is also asked whether he or she wishes to receive special offers from the service provider.

FIG. 7B illustrates an example web page 702 that could be used to collect additional information from the customer (such as in step 604 of the method 600) after the customer provides the initial information in FIG. 7A. In this example, the web page 702 asks the customer to enter his or her full mailing address and optionally the reason for checking credit information. The web page 702 also asks the customer to provide information to create an account, such as his or her email address, password, and security question. Note that the first name, last name, zip code, and email address of the customer in FIG. 7B could be pre-populated based on the information entered in FIG. 7A (although this need not occur). Also note that FIGS. 7A and 7B could be combined to collect all of this information using a single web page.

FIG. 7C illustrates an example web page 704 that could be used to collect Social Security and date of birth information from the customer.

FIG. 7D illustrates an example web page 706 that could be used to verify the customer's identity. As shown in FIG. 7D, the web page 706 includes a list of questions relating to the customer. In this particular example, the questions may relate to the customer's educational background, current or previous automobile(s), and current or previous automobile loan(s). However, any other suitable questions could be used to verify the customer's identity.

FIG. 7E illustrates an example web page 708 that could be used to collect information after the customer's identity has been verified (such as in step 638 of the method 600). As shown in FIG. 7E, the bottom portion of the web page 708 allows the customer to provide billing information. The top portion of the web page 708 contains preview information (such as in step 637 of the method 600). The preview information here includes the number of credit inquiries identified in the customer's credit report(s) compared to the average number of credit inquiries. However, as noted above, any other or additional information could be used as preview information.

Although FIGS. 7A through 7E illustrate one example of a graphical user interface that supports previewing credit reporting, credit monitoring, or other information prior to service enrollment, various changes may be made to FIGS. 7A through 7E. For example, information from a customer could be collected in any suitable manner using any suitable input mechanisms. Also, the identity of a customer could be confirmed in any suitable manner.

The use of preview information in this manner can help to encourage or entice a customer to sign up for a service. For example, the customer may review the preview information and notice something that appears incorrect. The customer would therefore be motivated to sign up for the service and verify whether the customer's information is correct. As another example, the preview information could show the customer what types of information are available using the service, encouraging the customer to sign up to review that information.

Note that the use of preview information (as shown in FIGS. 6 through 7E) can be separate from the verification of the customer's identity prior to enrolling in a service (as shown in FIGS. 3 through 5E). That is, preview information can be shown to a customer regardless of whether the customer enrolls before or after identity verification.

Also note that the description above has described the use of particular customer information (such as SSN/DOB information) and various types of customer verification information (such as residence and loan information). However, this disclosure is not limited to those types of information. Any information that uniquely identifies or verifies a customer (prior to account creation or service enrollment) could be used in the method 300 and by the system 100.

Further, note that various operations described above (such as the use of landing pages, emails, etc.) are for illustration only. Any suitable mechanisms can be used to interact with, provide data to, and receive data from a customer or potential customer. In addition, note that while it is assumed above that different devices (such as smartphones and desktop computers) could use different graphical user interfaces, a single graphical user interface could be shown on all user devices.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “communicate” and “receive,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and. C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving information over a network from a user device associated with a customer attempting to enroll in a service;
identifying service-related information associated with the customer, the service-related information comprising a subset or summary of information to be made available to the customer after the customer enrolls in the service; and
prior to enrolling the customer in the service, presenting the service-related information to the customer.

2. The method of claim 1, wherein:
receiving the information comprises receiving, from the user device, first information identifying the customer; and
the method further comprises verifying an identity of the customer.

3. The method of claim 2, wherein:
the method further comprises obtaining security information associated with the customer, wherein the security information is obtained from a source other than the customer using the first information; and
verifying the identity of the customer comprises verifying the identity of the customer using the security information and second information received from the user device.

4. The method of claim 3, wherein:
the security information comprises one or more questions associated with the customer; and
the second information comprises one or more answers to the one or more questions.

5. The method of claim 4, wherein the one or more questions comprise multiple questions, at least some of the questions related to current or prior addresses, loans, or vehicles of the customer.

6. The method of claim 2, further comprising:
after the identity of the customer is verified, enrolling the customer in the service, obtaining billing information of the customer for the service from the user device, and activating an online account for the customer.

7. The method of claim 1, wherein the service comprises a credit reporting service or a credit monitoring service.

8. The method of claim 7, wherein the service-related information comprises a summary of at least a portion of the customer's credit report.

9. The method of claim 8, wherein the service-related information further comprises a comparison of the summary of at least the portion of the customer's credit report to an average value.

10. An apparatus comprising:
at least one interface configured to receive information over a network from a user device associated with a customer attempting to enroll in a service; and
at least one processing device configured to:
identify service-related information associated with the customer, the service-related information comprising a subset or summary of information to be made available to the customer after the customer enrolls in the service; and
prior to enrolling the customer in the service, provide the service-related information to the customer.

11. The apparatus of claim 10, wherein:
the at least one interface is configured to receive, from the user device, first information identifying the customer; and
the at least one processing device is further configured to verify an identity of the customer.

12. The apparatus of claim 11, wherein:
the at least one processing device is further configured to obtain security information associated with the customer, wherein the security information is obtained from a source other than the customer using the first information; and
the at least one processing device is configured to verify the identity of the customer using the security information and second information received from the user device.

13. The apparatus of claim 12, wherein:
the security information comprises one or more questions associated with the customer; and
the second information comprises one or more answers to the one or more questions.

14. The apparatus of claim 11, wherein the at least one processing device is further configured, after the identity of the customer is verified, to enroll the customer in the service, obtain billing information of the customer for the service from the user device, and activate an online account for the customer.

15. The apparatus of claim 10, wherein:
the service comprises a credit reporting service or a credit monitoring service; and
the service-related information comprises a summary of at least a portion of the customer's credit report.

16. The apparatus of claim 15, wherein the service-related information further comprises a comparison of the summary of at least the portion of the customer's credit report to an average value.

17. A non-transitory computer readable medium embodying a computer program, the computer program comprising computer readable program code for:
obtaining information over a network from a user device associated with a customer attempting to enroll in a service;
obtaining service-related information associated with the customer, the service-related information comprising a subset or summary of information to be made available to the customer after the customer enrolls in the service; and
prior to enrolling the customer in the service, presenting the service-related information to the customer.

18. The computer readable medium of claim 17, wherein:
the computer readable program code for receiving the information comprises computer readable program code for receiving first information from the user device, the first information identifying the customer; and
the computer program further comprises computer readable program code for:
obtaining security information associated with the customer, wherein the security information is obtained from a source other than the customer using the first information; and
verifying an identity of the customer using the security information and second information received from the user device.

19. The computer readable medium of claim 18, wherein the computer program further comprises computer readable program code for:
after the identity of the customer is verified, enrolling the customer in the service, obtaining billing information of the customer for the service from the user device, and activating an online account for the customer.

20. The computer readable medium of claim 17, wherein:
the service comprises a credit reporting service or a credit monitoring service; and
the service-related information comprises (i) a summary of at least a portion of the customer's credit report and (ii) a comparison of the summary of at least the portion of the customer's credit report to an average value.
